(19) United States
(12) Patent Application Publication
(10) Pub. No.: US 2022/0044643 A1
(43) Pub. Date: Feb. 10, 2022

(54) DISPLAY BACKLIGHTING SYSTEMS AND METHODS HAVING CURRENT MIRROR BASED DISPLAY DRIVERS TO IMPROVE PULSE WIDTH MODULATION RESOLUTION

(71) Applicant: Apple Inc., Cupertino, CA (US)

(72) Inventors: Ming Gu, San Jose, CA (US); Asif Hussain, Clearwater, FL (US); Zhiyuan Hu, Santa Clara, CA (US); Marc Albrecht, San Francisco, CA (US); Jingdong Chen, San Jose, CA (US); Yanhui Xie, Cupertino, CA (US); Mohammad Jafar Navabi-Shirazi, Phoenix, AZ (US); Behzad Mohtashemi, Los Gatos, CA (US)

(21) Appl. No.: 17/223,929

(22) Filed: Apr. 6, 2021

Related U.S. Application Data
(60) Provisional application No. 63/060,983, filed on Aug. 4, 2020.

(51) Int. Cl. G09G 3/34; G09G 5/10

(52) U.S. Cl. CPC G09G 3/342; G09G 2320/064; G09G 5/10

(57) ABSTRACT

Aspects of the subject technology relate to an electronic device with a display. The display includes a plurality of light-emitting diodes and first and second driver circuits coupled to the plurality of light-emitting diodes. The first driver circuit is configured to receive a first pulse-width modulated (PWM) signal to control a first current mirror branch and the second driver circuit to receive a second PWM signal to control a second current mirror branch to provide an extra N bits of resolution for controlling the plurality of the light-emitting diodes.

### RELATED APPLICATIONS

This application claims the benefit of priority of U.S. Provisional Application No. 63/060,983 filed Aug. 4, 2020 which is incorporated herein by reference.

### TECHNICAL FIELD

The present description relates generally to electronic devices with displays, and more particularly, but not exclusively, to electronic devices with displays having backlights with local dimming.

### BACKGROUND

Electronic devices such as computers, media players, cellular telephones, set-top boxes, and other electronic equipment are often provided with displays for displaying visual information. Displays such as organic light-emitting diode (OLED) displays and liquid crystal displays (LCDs) typically include an array of display pixels arranged in pixel rows and pixel columns. Liquid crystal displays commonly include a backlight unit and a liquid crystal display unit with individually controllable liquid crystal display pixels.

The backlight unit commonly includes one or more light-emitting diodes (LEDs) that generate light that exits the backlight toward the liquid crystal display unit. The liquid crystal display pixels are individually operable to control passage of light from the backlight unit through that pixel to display content such as text, images, video, or other content on the display.

A backlight controller or driver chip converts input brightness information to current levels and current pulse duty cycle to drive LEDs or LED strings. LED current is controlled either using linear scaling of the current or by PWM control. Average current is controlled by adjusting the duty cycle of a fixed frequency PWM waveform. PWM brightness control is commonly used to avoid color shift. For PWM brightness control, PWM resolution is an important specification for the backlight performance. In a conventional method, PWM resolution relies on PLL frequency and PWM frequency.

PWM resolution=log₂(PLL frequency/PWM frequency).

To achieve high PWM resolution, high speed PLL is required, which increases the design complexity, area, and power consumption dramatically. For instance, for PWM frequency=20 kHz, a 12-bit PWM resolution needs a PLL to achieve 80 MHz frequency; a 13-bit PWM resolution needs a PLL to achieve 160 MHz frequency.

### SUMMARY OF THE DESCRIPTION

In accordance with various aspects of the subject disclosure, an electronic device with a display is provided. The display includes a plurality of light-emitting diodes. The display includes a plurality of light-emitting diodes and first and second driver circuits coupled to the plurality of light-emitting diodes. The first driver circuit is configured to receive a first pulse-width modulated (PWM) signal to control a first current mirror branch and the second driver circuit to receive a second PWM signal to control a second current mirror branch to provide extra N bits of resolution for controlling the plurality of the light-emitting diodes.

In accordance with other aspects of the subject disclosure, a computer implemented method for operating a display of an electronic device comprises generating, with a light-emitting diode (LED) circuit of the display, a first pulse-width modulated (PWM) signal to control a first current mirror branch of a first driver stage. The method includes generating a second PWM signal to control a second current mirror branch of a second driver stage to provide an extra N bits of resolution for controlling a plurality of light-emitting diodes of the LED circuit.

In accordance with other aspects of the subject disclosure, backlight circuitry comprises a plurality of light-emitting diodes to generate backlight for a display and first and second driver circuits coupled to the plurality of light-emitting diodes. The first driver circuit is configured to receive a first pulse-width modulated (PWM) signal to control a first current mirror branch and the second driver circuit to receive a second PWM signal to control a second current mirror branch to provide extra N bits of resolution for controlling the plurality of the light-emitting diodes.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example electronic device having a display in accordance with various aspects of the subject technology.

FIG. 2A illustrates a block diagram of a side view of an electronic device display having a backlight unit in accordance with various aspects of the subject technology.

FIG. 2B is a schematic diagram of device 100 showing illustrative circuitry that may be used in displaying images for a user of device 100 on pixel array 200 of display 110.

FIG. 3 shows a schematic diagram of exemplary display circuitry including control circuitry 300 that may be implemented in backlight unit or other LED lighting devices in accordance with an alternative embodiment.

FIG. 4 shows a schematic representation of exemplary circuitry of matrix drivers 306.

FIG. 5 illustrates a dual PWM driver of LED circuitry in accordance with one embodiment.

FIG. 6 illustrates a current mirror based LED circuitry with PWM control in accordance with one embodiment.

FIG. 7A illustrates a brightness code 700 in accordance with one embodiment.

FIG. 7B illustrates a graph of I_{LED} for driver circuitry 640 versus time.

FIG. 7C illustrates a graph of I_{LED} for driver circuitry 650 versus time.

FIGS. 8A-8I illustrate superposition effects for 10 plus 3 bits of resolution in accordance with one embodiment.

FIGS. 9A-9I illustrate superposition effects for 10 plus 3 bits of resolution in accordance with another embodiment.

FIGS. 10A-10I illustrate superposition effects for 10 plus 3 bits of resolution in accordance with another embodiment.

FIG. 11 illustrates a computer-implemented method 1100 of operating a display of an electronic device in accordance with one embodiment.

FIG. 12 illustrates a current mirror based LED circuitry with PWM control in accordance with another embodiment.

FIG. 13 illustrates a graph 1300 with LED versus brightness for a primary branch and two additional smaller current branches in accordance with one embodiment.

FIG. 14 illustrates the LED driver architecture with a current mirror in accordance with one embodiment.

FIGS. 15A-15E illustrate a PWM control mechanism for N branches in accordance with one embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In one embodiment, systems and methods are disclosed for improved pulse width modulation (PWM) resolution for current based mirror light-emitting diode (LED) drivers. These systems and methods improve the PWM resolution by adding at least one current mirror branch to the LED driver. In one example, the at least one current mirror branch has a current flow that is ½\hat{ }N of a full scale current output branch. This LED driver is based on a current mirror structure.

The subject disclosure provides electronic devices such as cellular telephones, media players, tablet computers, laptop computers, set-top boxes, smart watches, wireless access points, and other electronic equipment that include light-emitting diode arrays such as in backlight units of displays. Displays are used to present visual information and status data and/or may be used to gather user input data. A display includes an array of display pixels. Each display pixel may include one or more colored subpixels for displaying color images.

Each display pixel may include a layer of liquid crystals disposed between a pair of electrodes operable to control the orientation of the liquid crystals. Controlling the orientation of the liquid crystals controls the polarization of backlight. This polarization control, in combination with polarizers on opposing sides of the liquid crystal layer, allows light passing into the pixel to be manipulated to selectively block the light or allow the light to pass through the pixel.

The backlight unit includes one or more light-emitting diodes (LEDs) such as one or more strings and/or arrays of light-emitting diodes that generate the backlight for the display. In various configurations, strings of light-emitting diodes may be arranged along one or more edges of a light guide plate that distributes backlight generated by the strings to the LCD unit, or may be arranged to form a two-dimensional array of LEDs.

In a display, control circuitry coupled to the array of display pixels and to the backlight unit receives data for display from system control circuitry of the electronic device and, based on the data for display, generates and provides control signals for the array of display pixels and for the LEDs of the backlight unit.

In some scenarios, the backlight unit generates a constant amount of light for the display pixels and the amount of light that passes through each pixel is solely controlled by the operation of the liquid crystal display pixels. In other scenarios, the amount of light generated by the backlight is dynamically controlled, based on the content to be displayed on the display. In some devices with dynamic backlight control, individual backlight LEDs or groups of backlight LEDs are separately controlled to allow local dimming or brightening of the display to enhance the contrast generated by the LCD pixels. Control circuitry for the LEDs (e.g., for backlight LEDs) may include multiple matrix drivers, each for control of a subarray of an array of LEDs and each synchronized to a synchronization signal from a common controller. The control circuitry for the LEDs may include individual bypass switches for each LED to allow for local dimming at the level of individual LEDs.

Providing local dimming of the backlight LEDs in these disclosed configurations (e.g., using multiple driver circuits each dedicated to a subarray of LEDs and/or using individual LED dimming using bypass switches) allows the backlight circuitry to adjust brightness on a zone-by-zone basis within an image to be displayed. For example, backlight zones may be illuminated only in bright image areas and backlight zones may be dimmed or turned off in dark or black areas of an image. Local dimming in this way helps facilitate high dynamic range (HDR) display of images and improvements in color, contrast, motion-sharpness, and grey level.

Because display backlight units can include, in some implementations, a large number of LEDs (e.g., an array of tens, hundreds, thousands, or millions of LEDs), thermal management for LED backlights and/or other LED arrays can be challenging. The LED drive architectures disclosed herein, in which groups of LEDs and/or individual LEDs are independently controlled, can help reduce the thermal stress and/or energy loss by heat dissipation. Control systems and methods are also disclosed that reduce or minimize the headroom voltage for the backlight, which can also increase system efficiency.

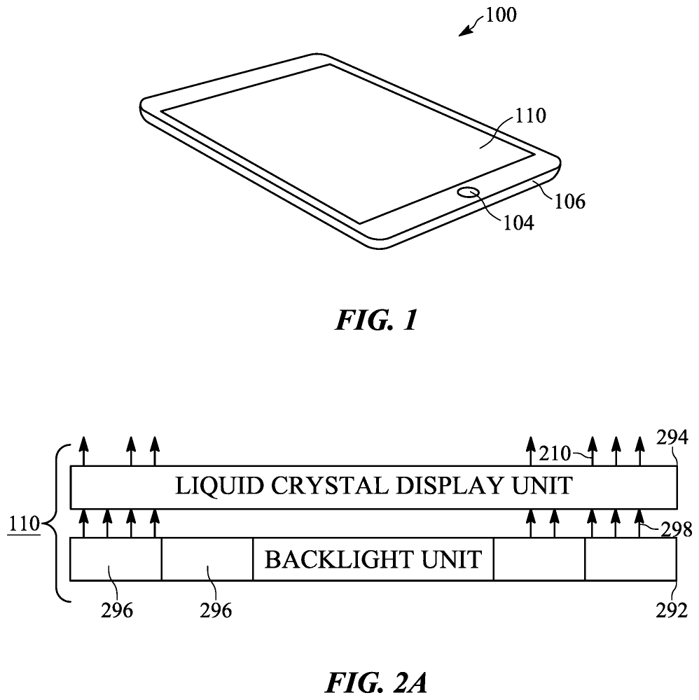

An illustrative electronic device having a display is shown in FIG. 1. In the example of FIG. 1, device 100 has been implemented using a housing that is sufficiently small to be portable and carried by a user (e.g., device 100 of FIG. 1 may be a handheld electronic device such as a tablet computer or a cellular telephone). As shown in FIG. 1, device 100 includes a display such as display 110 mounted on the front of housing 106. Display 110 may include a display panel having active display pixels in an active area of the display and control circuitry for operating the active display pixels in an inactive portion. Display 110 may have openings (e.g., openings in the inactive or active portions of display 110) such as an opening to accommodate button 104 and/or other openings such as an opening to accommodate a speaker, a light source, or a camera.

Display 110 may be a touch screen that incorporates capacitive touch electrodes or other touch sensor components or may be a display that is not touch-sensitive. Display 110 includes display pixels formed from light-emitting diodes (LEDs), organic light-emitting diodes (OLEDs), plasma cells, electrophoretic display elements, electrowetting display elements, liquid crystal display (LCD) components, or other suitable display pixel structures. Arrangements in which display 110 is formed using liquid crystal display (LCD) components and a backlight such as two-dimensional array of LEDs that backlight LCD pixels are sometimes described herein as an example. This is, however, merely illustrative. In various implementations, any suitable type of display pixel technology may be used in forming display 110 if desired.

Housing 106, which may sometimes be referred to as a case, may be formed of plastic, glass, ceramics, fiber composites, metal (e.g., stainless steel, aluminum, etc.), other suitable materials, or a combination of any two or more of these materials.

The configuration of electronic device 100 of FIG. 1 is merely illustrative. In other implementations, electronic device 100 may be a computer such as a computer that is integrated into a display such as a computer monitor, a laptop computer, a somewhat smaller portable device such as a wrist-watch device, a pendant device, or other wearable or miniature device, a media player, a gaming device, a navigation device, a computer monitor, a television, or other electronic equipment.

For example, in some implementations, housing 106 may be formed using a unibody configuration in which some or all of housing 106 is machined or molded as a single structure or may be formed using multiple structures (e.g., an internal frame structure, one or more structures that form exterior housing surfaces, etc.). Although housing 106 of FIG. 1 is shown as a single structure, housing 106 may have multiple parts. For example, housing 106 may have upper portion and lower portion coupled to the upper portion using a hinge that allows the upper portion to rotate about a rotational axis relative to the lower portion. A keyboard such as a QWERTY keyboard and a touch pad may be mounted in the lower housing portion, in some implementations.

In some implementations, electronic device 100 is provided in the form of a computer integrated into a computer monitor. Display 110 may be mounted on a front surface of housing 106 and a stand may be provided to support housing (e.g., on a desktop).

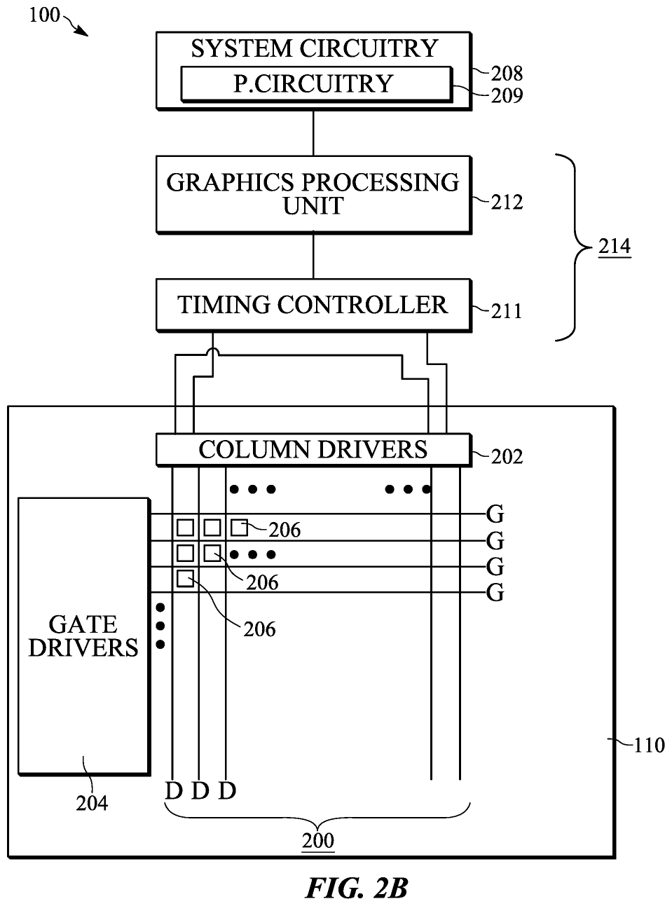

FIG. 2A is a schematic diagram of display 110 in which the display is provided with a liquid crystal display unit 294 and a backlight unit 292. As shown in FIG. 2A, backlight unit 292 generates backlight 298 and emits backlight 298 in the direction of liquid crystal display unit 294. Liquid crystal display unit 294 selectively allows some or all of the backlight 298 to pass through the liquid crystal display pixels therein to generate display light 210 visible to a user. Backlight unit 292 includes one or more subsections 296.

In some implementations, subsections 296 may be elongated subsections that extend horizontally or vertically across some or all of display 110 (e.g., in an edge-lit configuration for backlight unit 292). In other implementations, subsections 296 may be square or other rectilinear subsections (e.g., subarrays of a two-dimensional LED array backlight). Accordingly, subsections 296 may be defined by one or more strings and/or arrays of LEDs disposed in that subsection. Subsections 296 may be controlled individually for local dimming of backlight 298.

Although backlight unit 292 is shown implemented with a liquid crystal display unit, it should be appreciated that a backlight unit such as backlight unit 292 may be implemented in a backlit keyboard, or to illuminate a flash device or otherwise provide illumination for an electronic device.

FIG. 2B is a schematic diagram of device 100 showing illustrative circuitry that may be used in displaying images for a user of device 100 on pixel array 200 of display 110. As shown in FIG. 2B, display 110 may include column driver circuitry such as one or more column driver integrated circuits (CDICs) 202 that drive data signals (analog voltages) onto the data lines D of array 200. Display 110 may also include gate driver circuitry such as one or more gate drivers 204 (e.g., gate driver integrated circuits or GDICs) that drive gate line signals onto gate lines G of array 200.

Using the data lines D and gate lines G, display pixels 206 may be operated to display images on display 110 for a user. In some implementations, CDIC(s) 202 may be mounted on the display substrate with display pixels 206 or attached to the display substrate by a flexible printed circuit or other connecting layer. In some implementations, gate driver circuitry 204 may be implemented using thin-film transistor circuitry on a display substrate such as a glass or plastic display substrate or may be implemented using integrated circuits that are mounted on the display substrate or attached to the display substrate by a flexible printed circuit or other connecting layer. For example, gate driver circuitry 204 may include a plurality of gate driver integrated circuits directly formed on the display panel substrate (e.g., each configured to provide one or more gate signals along one or more corresponding ones of signal gate lines G for one or more corresponding rows of display pixels 206).

Device 100 may include system circuitry 208. System circuitry 208 may include one or more different types of storage such as hard disk drive storage, nonvolatile memory (e.g., flash memory or other electrically-programmable-read-only memory), volatile memory (e.g., static or dynamic random-access-memory), magnetic or optical storage, permanent or removable storage and/or other non-transitory storage media configure to store static data, dynamic data, and/or computer readable instructions for processing circuitry in system circuitry 208. Processing circuitry in system circuitry 208 may be used in controlling the operation of device 100. Processing circuitry 209 in system circuitry 208 may sometimes be referred to herein as system circuitry or a system-on-chip (SOC) for device 100.

The processing circuitry 209 may be based on a processor such as a microprocessor and other suitable integrated circuits, multi-core processors, one or more application specific integrated circuits (ASICs) or field programmable gate arrays (FPGAs) that execute sequences of instructions or code, as examples. In one suitable arrangement, system circuitry 208 may be used to run software for device 100, such as internet browsing applications, email applications, media playback applications, operating system functions, software for capturing and processing images, augmented reality (AR) applications, virtual reality (VR) applications, three-dimensional (3D) video applications, etc.

During operation of device 100, system circuitry 208 may generate or receive data that is to be displayed on display 110. This display data may be processed, scaled, modified, and/or provided with processing circuitry 209 to display control circuitry such as graphics processing unit (GPU) 212. For example, display frames, including display pixel values (e.g., each corresponding to a grey level) for display using pixels 206 (e.g., colored subpixels such as red, green, and blue subpixels) may be provided from system circuitry 208 to GPU 212. GPU 212 may process the display frames and provide processed display frames to timing controller integrated circuit 211.

Timing controller 211 provides digital display data (e.g., the digital pixel values each corresponding to a grey level for display) to CDIC(s) 202. Using digital-to-analog converter circuitry, bias circuitry, internal gamma voltage circuitry, level shifter circuitry, shift register circuitry, and/or the like within column driver circuitry 202, column driver circuitry 202 provides corresponding analog output signals on the data lines D running along the columns of display pixels 206 of array 200. Gate drivers 204 such as one or more gate driver integrated circuits (GDICs) on the display panel may receive timing and/or other control signals from timing controller 211.

Graphics processing unit 212 and timing controller 211 may sometimes collectively be referred to herein as display control circuitry 214. Display control circuitry 214 may be used in controlling the operation of display 110. Display control circuitry 214 may sometimes be referred to herein as a display driver, a display controller, a display driver integrated circuit (IC), or a driver IC. Graphics processing unit 212 and timing controller 211 may be formed in a common package (e.g., an SOC package) or may be implemented separately (e.g., as separate integrated circuits). In some implementations, timing controller 211 may be implemented separately as a display driver, a display controller, a display driver integrated circuit (IC), or a driver IC that receives processed display data from graphics processing unit 212. Accordingly, in some implementations, graphics processing unit 212 may be considered to be part of the system circuitry (e.g., together with system circuitry 208) that provides display data to the display control circuitry (e.g., implemented as timing controller 211, gate drivers 204, and/or CDIC(s) 202). Although a single gate line G and a single data line D for each pixel 206 are illustrated in FIG. 2B, this is merely illustrative and one or more additional row-wise and/or column-wise control lines may be coupled to each pixel 206 in various implementations.

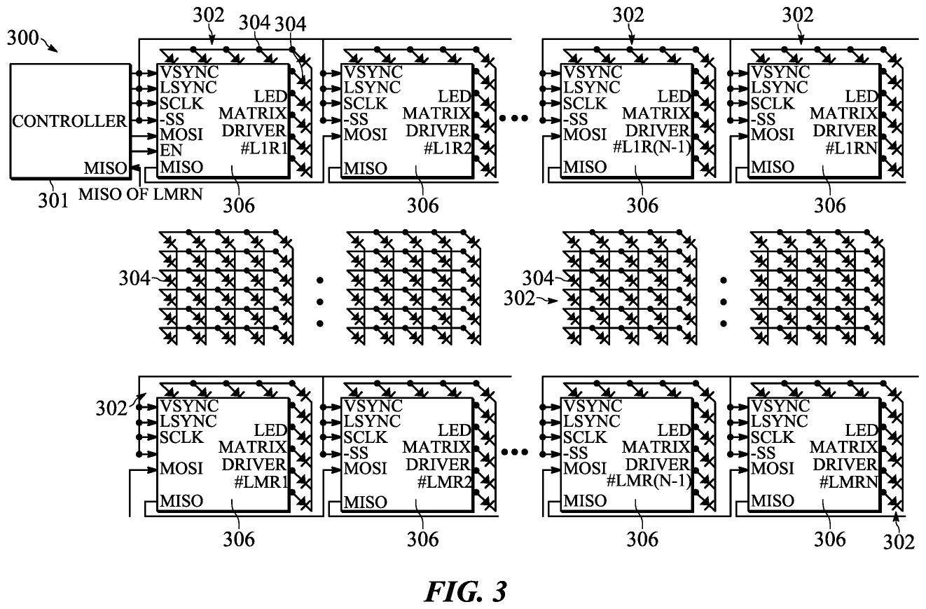

FIG. 3 shows a schematic diagram of exemplary display circuitry including control circuitry 300 that may be implemented in backlight unit or other LED lighting devices in accordance with an alternative embodiment. In the example of FIG. 3, control circuitry 300 includes multiple subarrays 302 of LEDs 304 that, in combination, form a two-dimensional array of LEDs. Each subarray 302 may include one or more strings of LEDs that each include multiple LEDs 304 in series. Subarrays 302 may each include multiple strings of LEDs that are coupled, in parallel, between a common supply voltage source and a current controller for that string.

Each subarray 302 includes a dedicated matrix driver circuit 306 (sometimes referred to simply as driver circuits for convenience) that operates the LEDs 304 in that array. Each matrix driver circuit 306 operates the LEDs 304 of its associated array 302 to provide local dimming of the entire array or local dimming of individual strings of LEDs in that array. Each matrix driver circuit 306 provides local dimming of LEDs 304, which may enhance the relative brightness and darkness of display content controlled by LCD unit 294. Accordingly, matrix driver circuitry 306 may operate the LEDs of their associated arrays 304 based, at least in part, on the content being displayed using LCD unit 294.

In order to operate the LEDs of an associated array 304 based, at least in part, on the content being displayed using LCD unit 294, each matrix driver circuitry 306 receives one or more control signals from a common controller 301. As shown in the example of FIG. 3, each matrix driver 306 receives the same vertical synchronization (VSYNC), line synchronization (LSYNC), serial clock (SCLK) and slave select (-SS) signal from controller 301. The VSYNC, LSYNC, SCLK and/or -SS signals may be signals used to operate the LCD pixels of LCD unit 294 as would be understood by one skilled in the art. For example, the VSYNC signal may be provided by controller 301 to indicate each display refresh or each display frame to be displayed using LCD pixels of the LCD unit. The LSYNC signal may be provided by controller 301 to signal the start of operation of each pixel row.

Controller 301 may be used to provide control signals such as the VSYNC and LSYNC signals, and/or other control signals, to both backlight unit 292 and LCD unit 294 or controller 301 may be a dedicated backlight control unit that receives the VSYNC, LSYNC, and/or other control signals from another display controller associated with LCD unit 294.

Each matrix driver 306 may update the brightness of its associated array 302 (e.g., the entire array or a subset of the array) based on the commonly received VSYNC signal (e.g., the brightness may be updated upon receipt of the rising edge of the VSYNC signal). In some implementations, each matrix driver 306 may include a programmable delay to set the relative timings of the various LED array updates based on the rising edge of the common VSYNC signal.

A first one of matrix drivers 306 (labeled LED Matrix Driver #L1R1 in FIG. 3) also receives and an enable signal (EN) and a Master-Out-Slave-In signal (MOSI) from common controller 301. LED Matrix Driver #L1R1 provides a Master-In-Slave-Out signal (MISO) to a next one of matrix drivers 306 (labeled LED Matrix Driver #L1R2 in FIG. 3), and so forth until a last one of matrix drivers 306 (labeled LED Matrix Driver #LMRN in FIG. 3). LED Matrix Driver #LMRN provides a MISO signal back to controller 301.

In some implementations, each matrix driver 306 may be an integrated circuit having an internal clock. However, due to process variations in manufacturing integrated circuits, an array of matrix drivers 306 each having its own clock can be problematic in that the operation of the various LED arrays 302 can be out of sync by as much as, for example, 10 percent. In order to ensure that the local dimming of LEDs 304 of various arrays 302 are synchronized to the associated content to be displayed, matrix drivers 306 are operated using a common (e.g., master) clock signal SCLK with synchronization of the various matrix drivers using the common LSYNC signal.

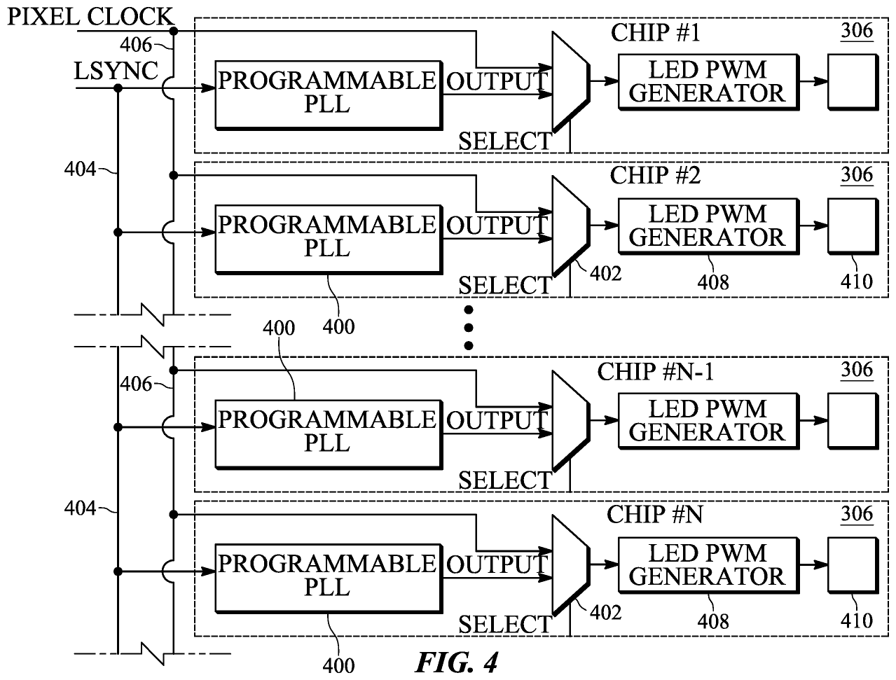

FIG. 4 shows a schematic representation of exemplary circuitry of matrix drivers 306. In the example of FIG. 4, each matrix driver 306 includes a programmable phase lock loop (PLL) 400. Each PLL 400 receives the common LSYNC signal along a path 404 from common controller 301 of FIG. 3 and generates a synchronization output signal which is provided to a multiplexer 402. Each multiplexer 402 also receives the clock signal (labeled Pixel Clock in FIG. 4 and SCLK in FIG. 3) along a path 406 from common controller 301.

Based on a selection signal “Select”, each multiplexer 402 generates a driver clock signal for its associated matrix driver 306, the driver clock signal geared from the LSYNC synchronized PLL signal and/or the clock signal. The selected driver clock signal is provided to a pulse-width modulation (PWM) generator 408 that generates a PWM signal, based on the provided driver clock signal, for use in controlling the brightness of the LEDs (e.g., in one or more strings) in the array 302 associated with that matrix driver 306.

The PWM signal from the PWM generator 408 of each matrix driver 306 is provided to LED control circuitry 410 of that matrix driver 306 for controlling the brightness of LEDs 304 of that array 302 associated with that matrix driver 306. LED control circuitry 410 of each matrix driver 306 may include, for example, a DC/DC converter or switching converter (e.g., implemented as a buck converter, a boost converter, a buck boost converter, or an inverter) for providing a supply voltage to a first end of each LED string in the associated array 302. The supply voltage generated by LED control circuitry 410 is based on the PWM signal provided by the associated LED PWM generator 408.

LED control circuitry 410 of each matrix driver 306 may also include additional circuitry such as a current driver circuitry or controlling current at a second end of each string of LEDs, may include headroom voltage control circuitry, and/or may include individual LED switching circuitry (e.g., in implementations in which each LED in a string is provided with a bypass switch as described in further detail hereinafter).

Each matrix driver 306 may also include headroom voltage control circuitry that provides feedback control of LED arrays 302 to help reduce energy loss by reducing or minimizing residual voltages at the end of each LED string.

The present design improves the PWM Resolution without increasing a clock frequency through adding one or more extra current mirror branches. In one example, current flow is only ½\hat{ }N of the full scale current output branch. In another example, each current mirror branch has an equal current. With an extra current mirror branch, the present design can achieve extra N bits of resolution. The underlying principle is using the extra branch (e.g., small current, ½\hat{ }N of the primary current branch) to implement a least significant bit (LSB) or a most significant bit (MSB) of the brightness code while using the primary current branch to implement one or more different bits of the brightness code. In one example, if the current of the small branch is ⅛ of the primary current branch, then the small current branch represents 3 LSBs. Both additional branches and the primary branch can be turned on simultaneously within one PWM cycle.

This method of adding one or more extra current mirror branches produces extra bits of resolution within one PWM cycle, while a conventional dither method has to be completed in a couple of PWM cycles. In the scenario in which dither is not applicable, e.g., the PWM cycles allowed in one refresh period is small, our method improves the resolution more effectively. Moreover, method of the present design is still compatible with dither technology. Hence in addition to adding bits with dither, the resolution bits can be increased even more. Dithering is a method that enhances the resolution without increasing the clock frequency. In dithering control, multiple PWM dimming clock cycles are used as combination of different duty cycles spread over multiple PWM dimming clock cycles to achieve intermediate averaged LED current values. Enhanced PWM resolution equals PWM resolution plus number of bits of dithering. The PWM cycle number required for M-bit of dither pattern is 2^{M}.

A conventional approach for mixed mode dimming with PWM and linear driver uses PWM control at low brightness levels below a switch point. Linear dimming with the linear driver including a digital to analog converter (DAC) is performed for brightness levels above the switch point. This conventional approach requires a high speed clock to achieve high resolution PWM and also requires a phase locked loop (PLL) circuit to multiply a reference clock signal. A high resolution DAC is required to control linear current dimming and this DAC consumes a large die area. The driver with high speed clock converts DAC output to LED current and this has high current consumption.

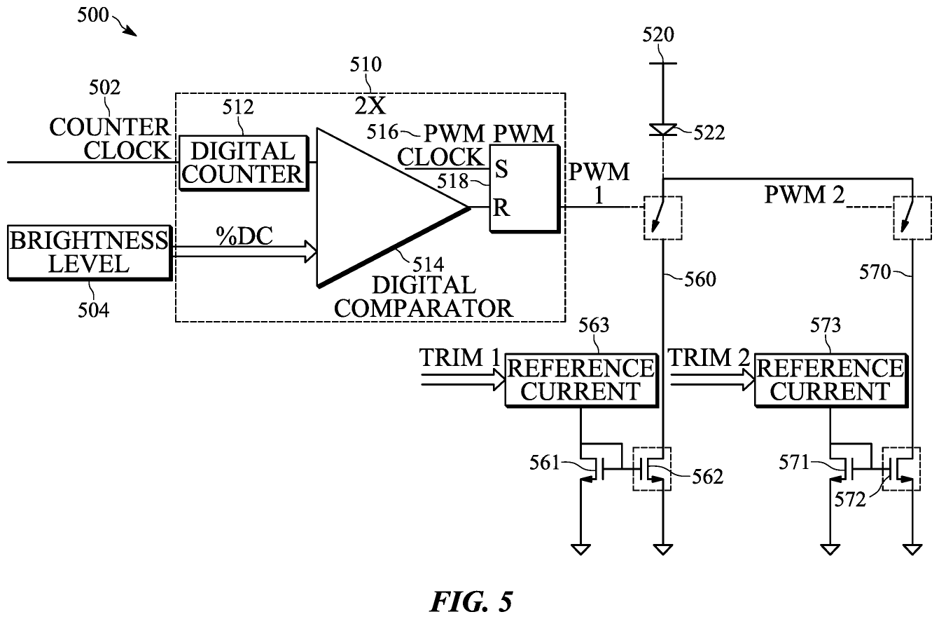

A driver of the present design is based on a current mirror structure for PWM control for high overall resolution and no linear driver with DAC is needed for this design. In one example, a dual PWM driver of LED circuitry as illustrated in FIG. 5 in accordance with one embodiment provides higher overall resolution. The dual PWM driver converts input brightness information to current levels to drive LEDs 522 (e.g., implemented in LED strings). The LED circuitry 500 does not require an increase in clock frequency to improve resolution. The LED circuitry (e.g., backlight circuitry) 500 does not require a DAC. The LED circuitry 500 includes a PWM controller 510 that is replicated for each driver circuitry 560 and 570 or driver stage. A first PWM controller 510 generates the PWM 1 signal and a second PWM controller 510 generates the PWM 2 signal. In one example, the PWM controller provides a fixed peak current to operate switches such that average current through one or more LEDs 522 is controlled by adjusting the duty cycle of a fixed frequency PWM waveform.

The driver circuitry 560 includes a switch and transistor 562. The switch (e.g., transistor) is operated based on the input PWM 1 and this drives the one or more LEDs 522. The driver circuitry 570 includes a switch and transistor 572. The switch (e.g., transistor) is operated based on the input PWM 2 and this drives the one or more LEDs 522. The PWM controller 510 includes a digital counter 512 that receives a high frequency PLL clock or counter clock signal 502 and outputs an output signal to digital comparator 514, which compares the output signal to brightness signal having duty cycle information and provided by brightness level 504. When the output signal reaches a certain value based on a count being incremented or decremented by the counter, then a desired brightness level is achieved and the digital comparator generates an output signal. The PWM circuitry 518 receives PWM clock signal 516 and output from the digital comparator 514 to generate PWM signals (e.g., PWM 1 provided to driver circuitry 560 and PWM 2 provided to driver circuitry 570) with current level information. The PWM signals control the brightness level of display elements such as LED 522, which is coupled to voltage supply circuitry 520.

A reference current level of each driver circuitry is set by an accurate reference (e.g., reference current 563, reference current 572) with trim (e.g., trim 1, trim 2). Each driver circuitry is based on a current mirror branch with transistor 561 been coupled to transistor 562 while transistor 571 is coupled to transistor 572. A reference current is provided to gate terminals of the transistors. The LED circuitry 500 provides open loop control of current through current mirror based driver circuitry 560 and 570. A high speed closed loop amplifier is not needed for each driver circuitry. The LED circuitry 500 does include 2 PWM controllers 510 for signal generation and independent trimming for each reference current level.

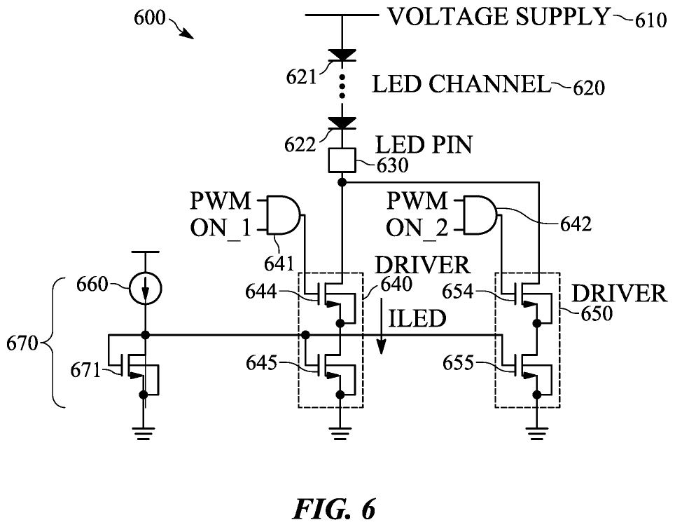

FIG. 6 illustrates a current mirror based LED circuitry with PWM control in accordance with one embodiment. The LED circuitry 600 includes a voltage supply circuit 610 which may be implemented with a switching regulator (e.g., a buck converter or a boost converter), a LED channel 620 that has a string of LEDs (e.g., series connected LEDs 621 and 622), and a LED pin 630 to measure a residual voltage for headroom voltage control at an end of this string of LEDs. A current source 660 (or current sink) provides a current to transistors of the current mirror circuitry 670. A PWM generator or controller provides the PWM signals to logic 641, 642 (e.g., AND gates 641, 642) and output from the logic is provided to gates of the driver circuitry 640 and 650. The PWM generator or controller converts input brightness information to current levels to drive LEDs 621 and 622 (e.g., implemented in LED strings). The LED circuitry 600 does not require an increase in clock frequency to improve resolution. The ON 1 and 2 signals can be used as inputs for the logic 641, 642. Driver circuitry 640 includes transistors 644 and 645 and can be a primary or main current mirror branch while driver circuitry 650, which includes transistors 654 and 655, is an additional smaller current mirror branch to provide an extra N bits of resolution. In one example, the primary branch to additional branch ratio is 1:½^{N}.

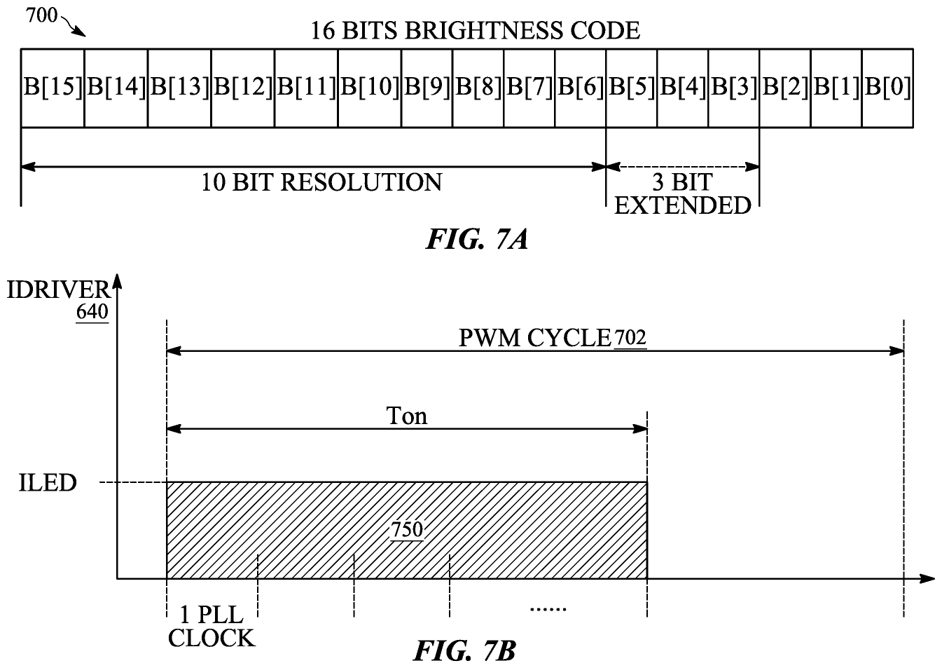

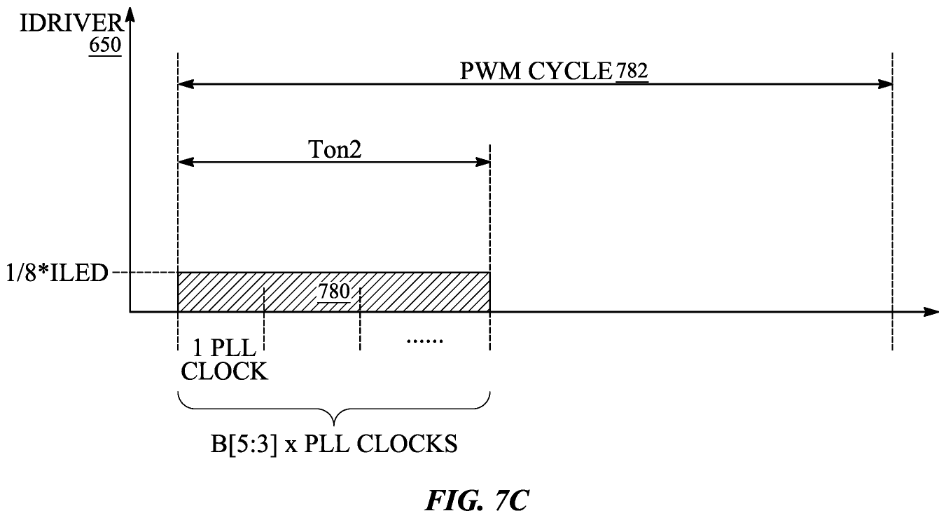

FIG. 7A illustrates a brightness code 700 in accordance with one embodiment. The code 700 in this example includes 16 bits including 10 bit resolution (e.g., B[15:6]) and 3 bit extended (e.g., B[5:3]).

If the PWM Resolution is 10 bit, then T_{ON}=b[15:6]×T_{PLL clock}. FIG. 7B illustrates a graph of I_{LED} for driver circuitry 640 versus time. A shaded area 750 represents an integral of LED current within one PWM cycle 702.

Area_10 bits=Iled×T_{ON}=Iled×B[15:6]×T_PLLclock

In this example, the following equations describe how the area would be impacted if there were 3 additional bits of resolution.

T_{ON}=(B[15:6]+(B[5:3])/2\hat{ }3)×T_PLLclock

It is desired to obtain the following:

Area_(10+3 bits)=Iled×T_{ON}=Iled×(B[15:6]+(B[5:3])/2\hat{ }3)×T_PLLclock

FIG. 7C illustrates a graph of I_{LED} for driver circuitry 650 versus time. A shaded area 780 represents an integral of LED current within one PWM cycle 782. The shaded areas 750 and 780 can be added based on the following equations to obtain 3 extra bits of resolution.

$$Area\_driver 640 , 650 = Iled \times {T}_{ON} + 1 / 8 Iled \times {T}_{ON 2} = Iled \times B [ 15 \text{:} 6 ] \times T\_PLLclock + 1 / 8 Iled \times B [ 5 \text{:} 3 ] \times T\_PLLclock = Iled \times ( B [ 15 \text{:} 6 ] + 1 / 8 \times B [ 5 \text{:} 3 ] ) \times T\_PLLclock$$

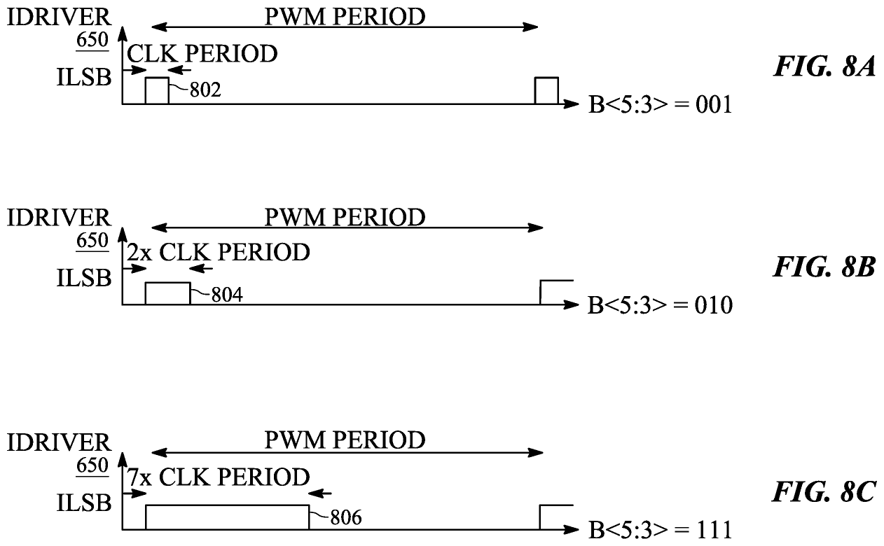

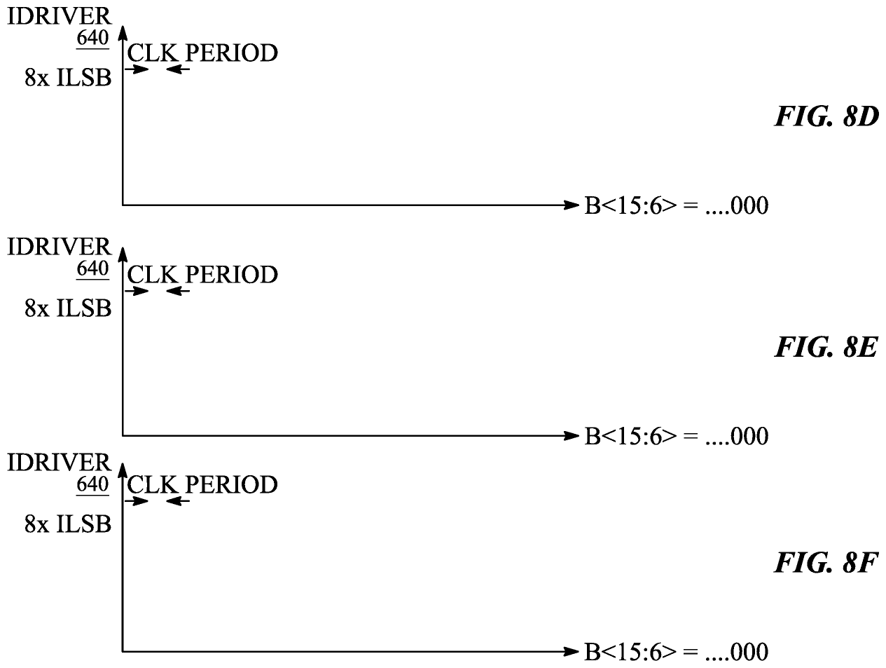

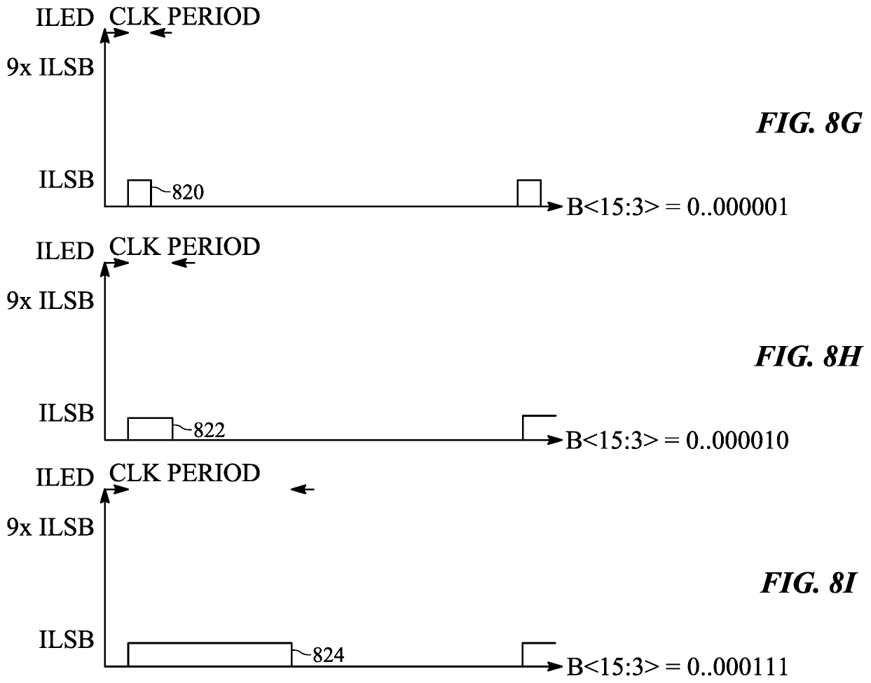

FIGS. 8A-8I illustrate superposition effects for 10 plus 3 bits of resolution in accordance with one embodiment. FIG. 8A illustrates a graph of I_{LED} for driver circuitry 650 versus time for 3 extra bits (e.g., B[5:3]=001) during a single clock period within a PWM period. An area 802 represents an integral of LED current within one PWM period.

FIG. 8B illustrates a graph of I_{LED} for driver circuitry 650 versus time for 3 extra bits (e.g., B[5:3]=010) during two clock periods within a PWM period. An area 804 represents an integral of LED current within one PWM period. FIG. 8C illustrates a graph of I_{LED} for driver circuitry 650 versus time for 3 extra bits (e.g., B[5:3]=111) during seven clock periods within a PWM period. An area 806 represents an integral of LED current within one PWM period.

FIGS. 8D, 8E, and 8F illustrate graphs of I_{LED} for driver circuitry 640 versus time for 10 bits (e.g., B[15:6]=000) during a single clock period within a PWM period. FIG. 8G illustrates a superposition of graphs from FIGS. 8A and 8D to produce area 820 for 13 bits (e.g., B[15:3]=0.000001) during a single clock period within a PWM period. FIG. 8H illustrates a superposition of graphs from FIGS. 8B and 8E to produce area 822 for 13 bits (e.g., B[15:3]=0.000010) during two clock periods within a PWM period. FIG. 8I illustrates a superposition of graphs from FIGS. 8C and 8F to produce area 824 for 13 bits (e.g., B[15:3]=0.000111) during seven clock periods within a PWM period.

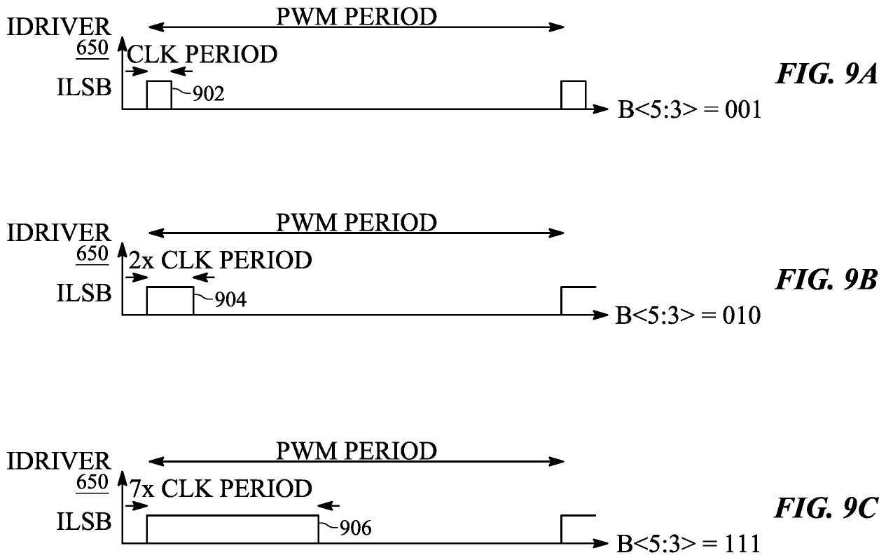

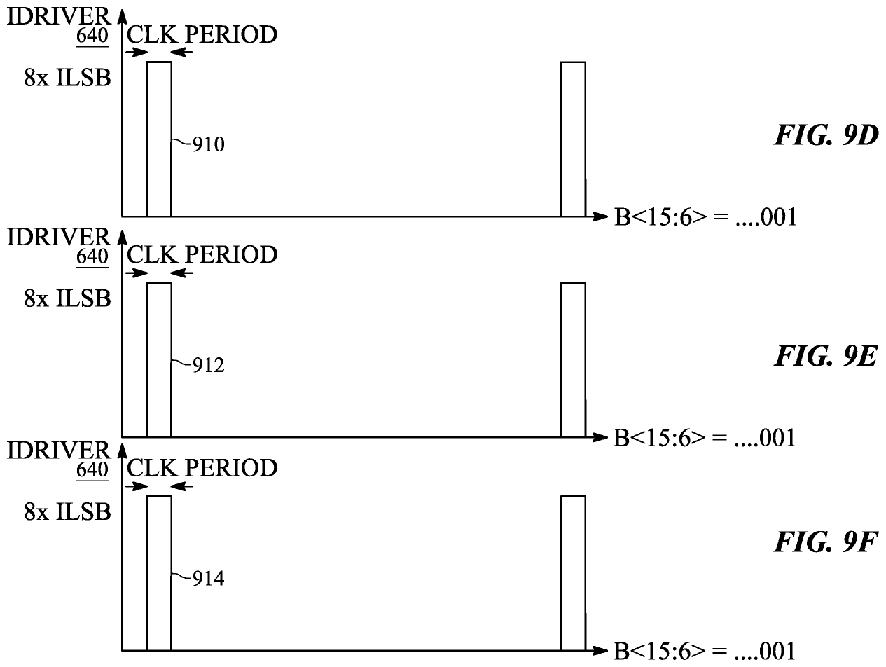

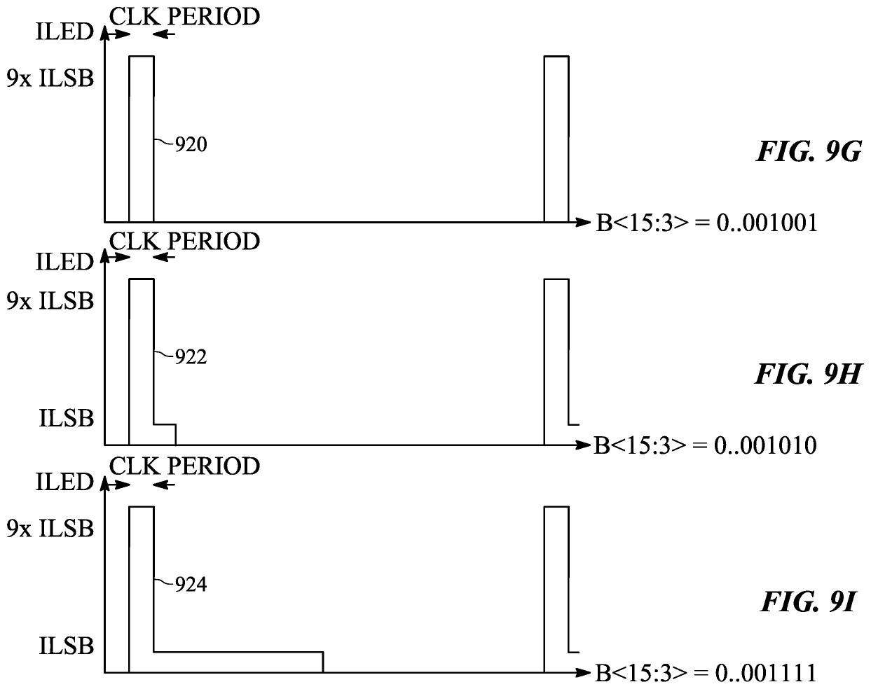

FIGS. 9A-9I illustrate superposition effects for 10 plus 3 bits of resolution in accordance with another embodiment. FIG. 9A illustrates a graph of I_{LED} for driver circuitry 650 versus time for 3 extra bits (e.g., B[5:3]=001) during a single clock period within a PWM period. An area 902 represents an integral of LED current within one PWM period.

FIG. 9B illustrates a graph of I_{LED} for driver circuitry 650 versus time for 3 extra bits (e.g., B[5:3]=010) during two clock periods within a PWM period. An area 904 represents an integral of LED current within one PWM period. FIG. 9C illustrates a graph of I_{LED} for driver circuitry 650 versus time for 3 extra bits (e.g., B[5:3]=111) during seven clock periods within a PWM period. An area 906 represents an integral of LED current within one PWM period.

FIGS. 9D, 9E, and 9F illustrate graphs of I_{LED} for driver circuitry 640 versus time with areas 910, 912, and 914 for 10 bits (e.g., B[15:6]=001) during a single clock period within a PWM period. FIG. 9G illustrates a superposition of graphs from FIGS. 9A and 9D to produce area 920 for 13 bits (e.g., B[15:3]=0.001001) during a single clock period within a PWM period. FIG. 9H illustrates a superposition of graphs from FIGS. 9B and 9E to produce area 922 for 13 bits (e.g., B[15:3]=0.001010) during two clock periods within a PWM period. FIG. 9I illustrates a superposition of graphs from FIGS. 9C and 9F to produce area 924 for 13 bits (e.g., B[15:3]=0.001111) during seven clock periods within a PWM period.

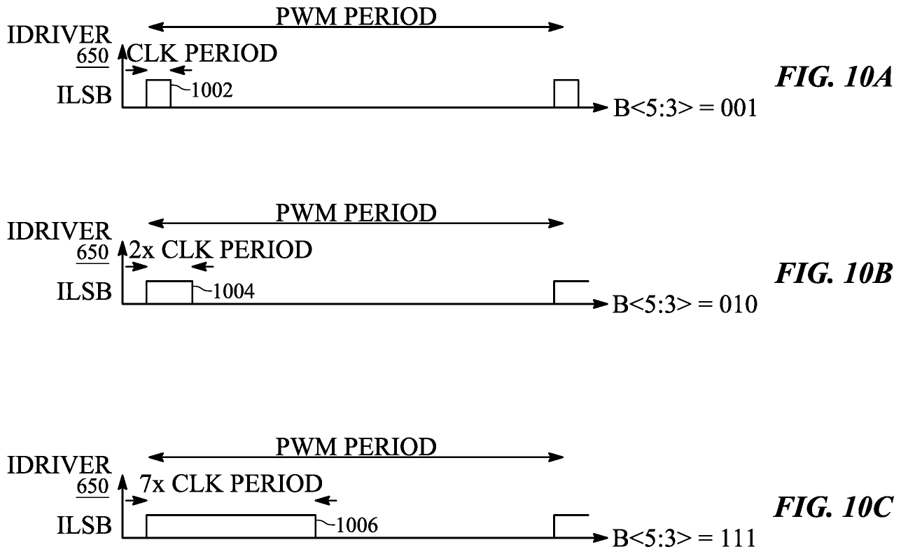

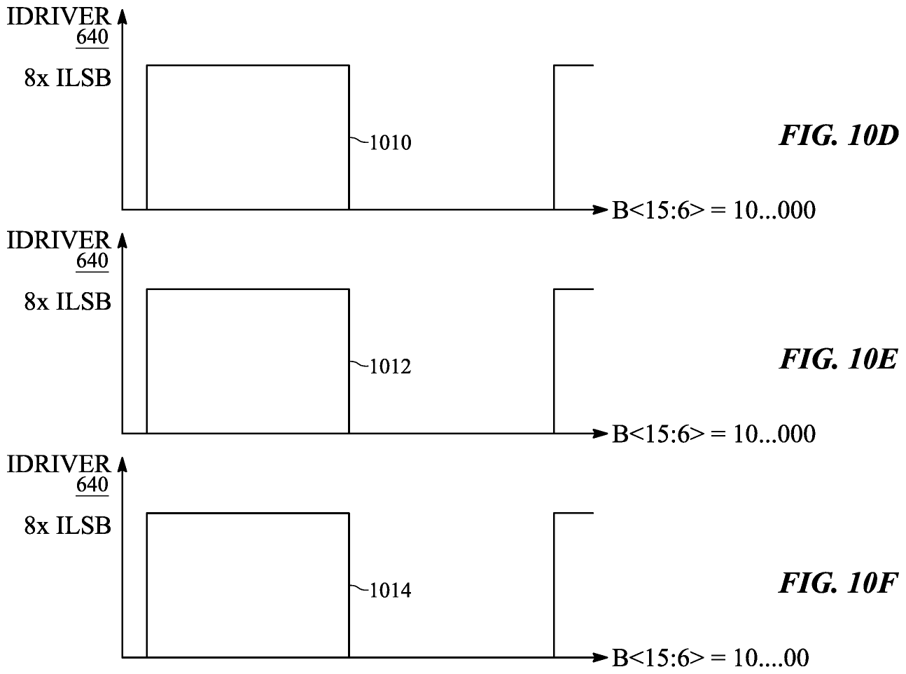

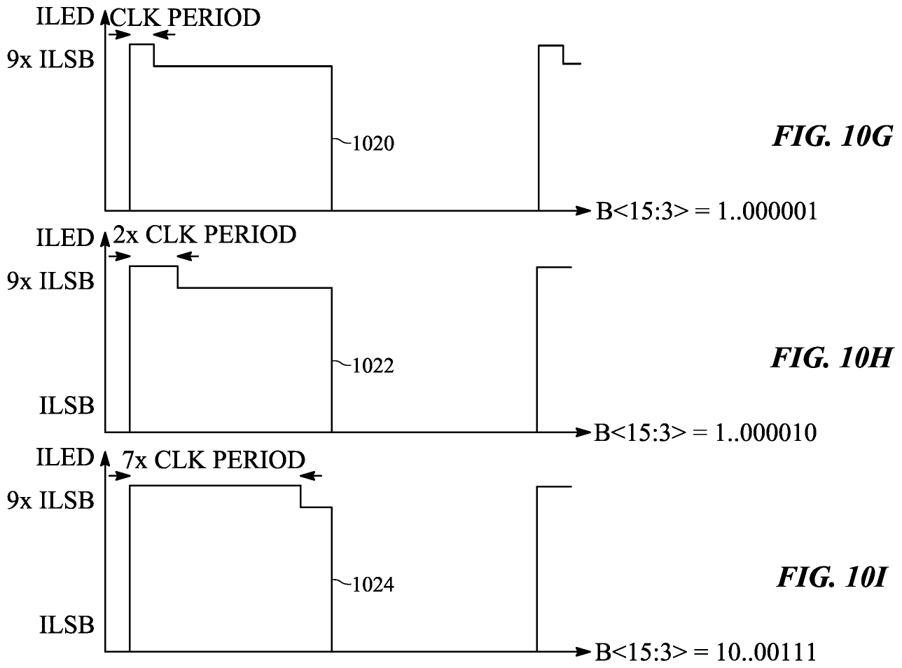

FIGS. 10A-10I illustrate superposition effects for 10 plus 3 bits of resolution in accordance with another embodiment. FIG. 10A illustrates a graph of I_{LED} for driver circuitry 650 versus time for 3 extra bits (e.g., B[5:3]=001) during a single clock period within a PWM period. An area 1002 represents an integral of LED current within one PWM period.

FIG. 10B illustrates a graph of I_{LED} for driver circuitry 650 versus time for 3 extra bits (e.g., B[5:3]=010) during two clock periods within a PWM period. An area 1004 represents an integral of LED current within one PWM period. FIG. 10C illustrates a graph of I_{LED} for driver circuitry 650 versus time for 3 extra bits (e.g., B[5:3]=111) during seven clock periods within a PWM period. An area 1006 represents an integral of LED current within one PWM period.

FIGS. 10D, 10E, and 10F illustrate graphs of I_{LED} for driver circuitry 640 versus time with areas 1010, 1012, and 1014 for 10 bits (e.g., B[15:6]=10 . . . 000) during a single clock period within a PWM period. FIG. 10G illustrates a superposition of graphs from FIGS. 10A and 10D to produce area 1020 for 13 bits (e.g., B[15:3]=10.000) during a single clock period within a PWM period. FIG. 10H illustrates a superposition of graphs from FIGS. 10B and 10E to produce area 1022 for 13 bits (e.g., B[15:3]=1.000010) during two clock periods within a PWM period. FIG. 10I illustrates a superposition of graphs from FIGS. 10C and 10F to produce area 1024 for 13 bits (e.g., B[15:3]=10.00111) during seven clock periods within a PWM period.

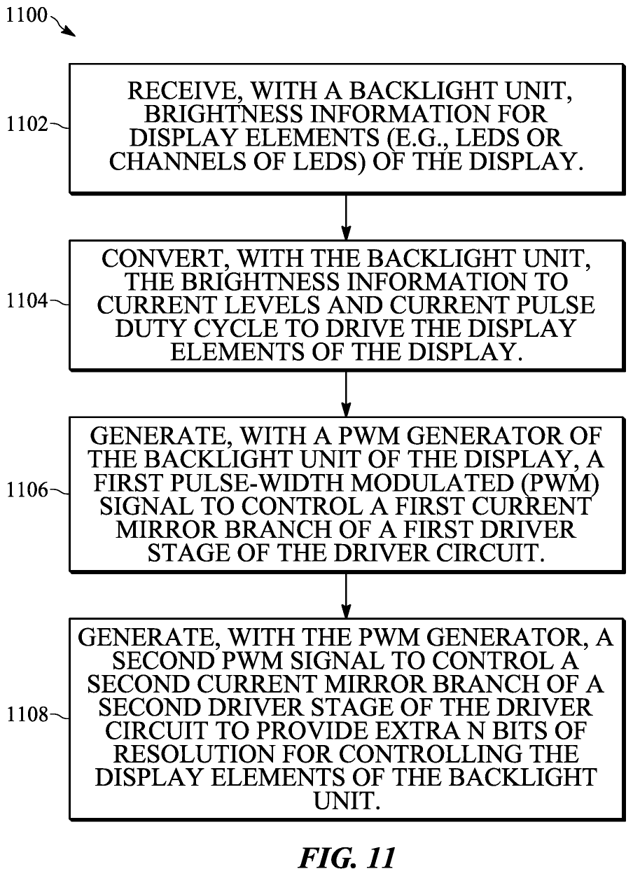

For explanatory purposes, the blocks of the example computer-implemented method 1100 of operating a display of an electronic device of FIG. 11 are described herein as occurring in series, or linearly. However, multiple blocks of the example method of FIG. 11 may occur in parallel. In addition, the blocks of the example method of FIG. 11 need not be performed in the order shown and/or one or more of the blocks of the example method of FIG. 11 need not be performed. A backlight unit, display circuitry, control circuitry, matrix drivers, PWM generator, processing circuitry (e.g., processor executing instructions for an algorithm) may perform one or more of the operations of FIG. 11. This circuitry may include hardware (circuitry, dedicated logic, etc.), software (such as is run on a general purpose computer system or a dedicated machine or a device), or a combination of both.

In the depicted example flow diagram, at operation 1102, the method includes receiving, with a backlight unit, brightness information for display elements (e.g., LEDs or channels of LEDs) of the display. At operation 1104, the method includes converting, with the backlight unit, the brightness information to current levels and current pulse duty cycle to drive the display elements of the display. At operation 1106, the method includes generating, with a PWM generator of the backlight unit of the display, a first pulse-width modulated (PWM) signal to control a first current mirror branch of a first driver stage of the driver circuit. At operation 1108, the method includes generating, with the PWM generator, a second PWM signal to control a second current mirror branch of a second driver stage of the driver circuit to provide extra N bits of resolution for controlling the display elements of the backlight unit. The second current mirror branch provides the extra N bits of resolution without increasing a clock frequency for the PWM generator.

In one example, the first current mirror branch to second current mirror branch ratio is 1:½^{N}. The second current mirror branch provides extra N bits of resolution during a single PWM period. The driver circuitry does not have a digital to analog converter (DAC) to minimize area. The first and second PWM signals control a brightness level of the channel of light-emitting diodes, which is coupled to a voltage supply circuitry.

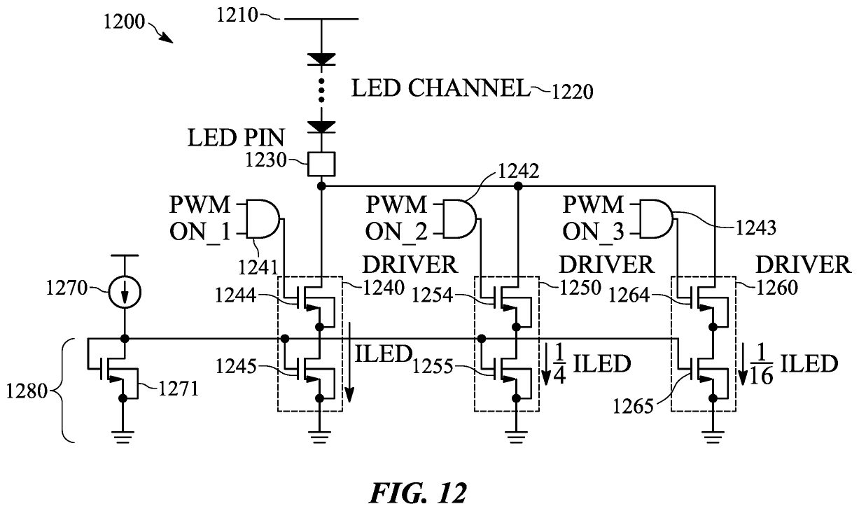

The computer-implemented method 1100 does not need a high frequency PLL to generate a clock signal for the PWM generator. This method is compatible with dither technology.
In another example, the present design includes PWM mode LED driver with multi-stage resolution enhancement as illustrated in FIG. 12. A DAC can be removed with a PWM brightness control method and this significantly reduces an area needed for the driver circuit (e.g., LED driver integrated circuit (IC)).

FIG. 12 illustrates current mirror based LED circuitry with PWM control in accordance with another embodiment. The LED circuitry 1200 such as a backlight circuitry includes a voltage supply circuit 1210 which may be implemented with a switching regulator (e.g., a buck converter or a boost converter), a LED channel 1220 that has a string of LEDs, and a LED pin 1230 to measure a residual voltage at an end of this string of LEDs. A current source 1270 provides a current to transistors of the current mirror circuitry 1280. A PWM generator provides the PWM signals to logic 1241, 1242, and 1243 (e.g., AND gates 1241, 1242, 1243) and output from the logic is provided to gates of the driver circuitry 1240, 1250, and 1260. The PWM generator converts input brightness information to current levels to drive LEDs of LED channel 1220 (e.g., implemented in LED strings). The ON 1, ON 2, and ON 3 signals can be used as inputs for the corresponding logic 1241, 1242, and 1243. Driver circuitry 1240 includes transistors 1244 and 1245 and can be a primary or main current mirror branch that is labeled with a current of I_{LED} in FIG. 12. Driver circuitry 1250, which includes transistors 1254 and 1255, is an additional smaller current mirror branch that is labeled as ¼ I_{LED}. Driver circuitry 1260, which includes transistors 1264 and 1265, is an additional smaller current mirror branch that is labeled as 1/16 I_{LEA}. The additional current branches provide an extra N bits of resolution without increasing a clock frequency that is designed for the PWM generator and the M bits (e.g., 10 bits, 12 bits, etc.) of resolution of the main current branch I_{LED}. In one example, the primary branch to additional branch ratio is 1:½^{N}. The PWM resolution can be increased with one or more extra current mirror branches (e.g., ¼ LED, 1/16 I_{LED}). N is determined by the smallest branch (e.g., in FIG. 12, N=4 since 1/16 of driver 1260 equals ½⁴).

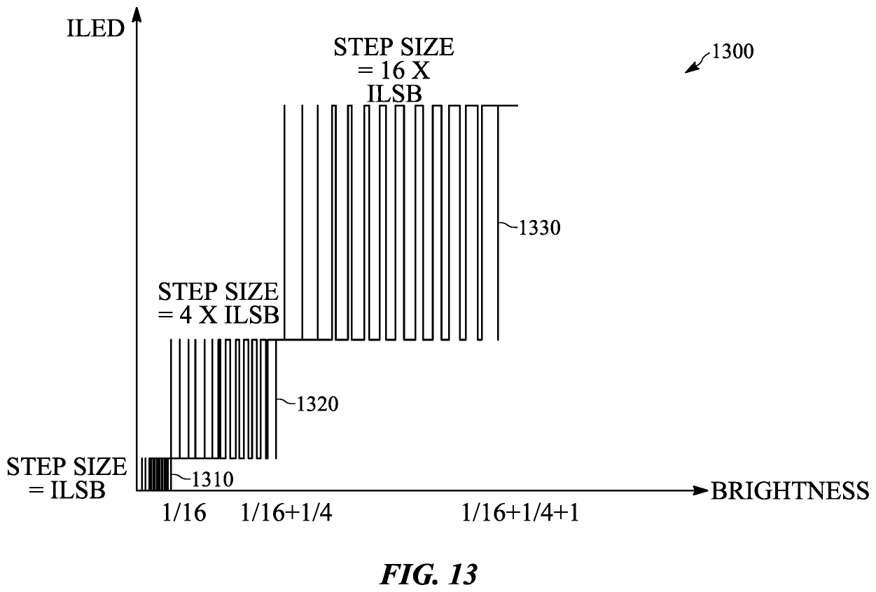

FIG. 13 illustrates a graph 1300 with I_{LED} versus brightness for a primary branch and two additional smaller current branches in accordance with one embodiment. Each branch of FIG. 12 is turned ON based on the PWM resolution. In one example, the PWM generator provides a sequence of PWM signals to turn ON the smallest branch 1/16 I_{LED}, the intermediate branch ¼ LED, and then the primary largest branch LED.

The PWM signals are generated based on software code and in computing the least significant bit is the bit position in a binary integer giving the units value, that is, determining whether the number is even or odd. The most significant bit is the bit position in a binary number having the greatest value. The primary current branch can have a current level that corresponds to the most significant bit (MSB). The smaller branches have current levels that correspond to the LSBs. A PWM signal 1310 has a step size of a LSB for the smallest branch 1/16 I_{LED}. A PWM signal 1320 has a step size of 4*LSB for the intermediate branch ¼ I_{LED}. A PWM signal 1330 has a step size of 16*LSB for the largest primary branch.

A mixed mode dimming method includes both PWM dimming for lower current levels and linear dimming for higher current levels above a threshold level. When the brightness for a display is larger than the threshold level, the LED driver is working in linear dimming mode. In this mode, the LED current is adjusted proportional to brightness change. When brightness is lower than the threshold level, the LED driver is working in PWM dimming mode. Note that the threshold level can also be programmed at maximum current. In this case, the driver has no linear mode and it will be in pure PWM mode

A typical LED driver architecture that can support the mixed mode dimming needs a DAC to provide reference voltage for the closed loop current control. It also needs a high speed op-amp to close the loop.

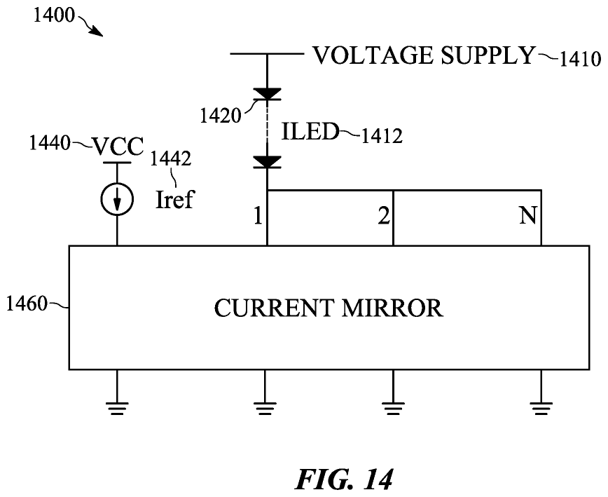

The present design includes a LED driver architecture with a current mirror and no DAC for PWM control. FIG. 14 illustrates the LED driver architecture with a current mirror in accordance with one embodiment. The LED circuitry 1400 includes a voltage supply 1410, a channel of display elements (e.g., LEDs) having current I_{LED} 1412, a voltage supply 1440 (e.g., a common collector supply voltage Vcc 1440), a current source Iref 1442, and a current mirror 1460.

The current mirror 1460 has N branches. In one example, every branch has the same targeted current ratio relative to reference current Iref.

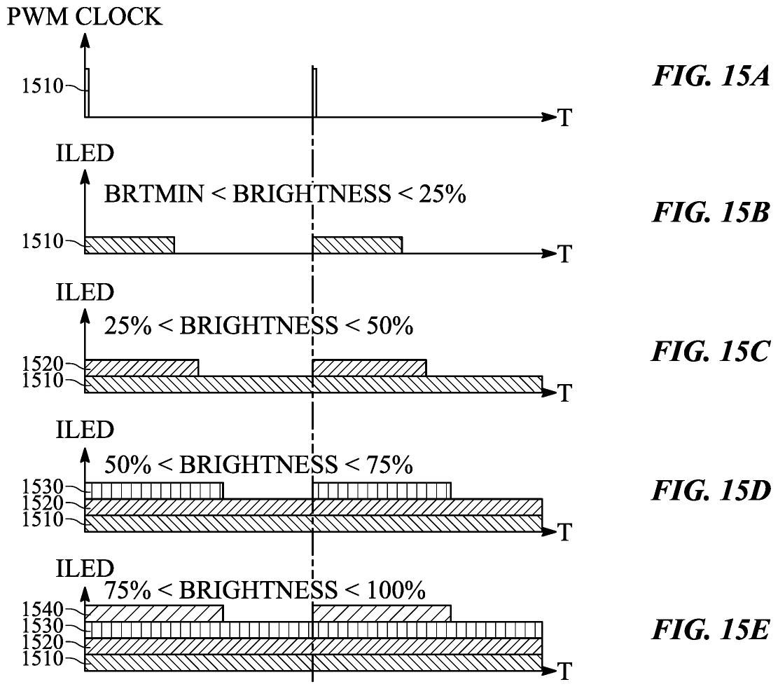

FIGS. 15A-15E illustrate a PWM control mechanism for N branches in accordance with one embodiment. FIG. 15A illustrates a PWM clock signal versus time. In one example, N=4 and with 4 equal branches, the first branch has a current level 1510 while being in PWM mode and the remaining branches will be off if brightness is less than 25% as illustrated in FIG. 15B. If brightness is between 25% and 50%, the first branch will stay ON with the current level 1510 (e.g., maximum current level) and the 2nd branch will have a current level 1520 while being in PWM mode. If brightness is between 50% and 75%, the 1st and 2nd branches will stay ON (e.g., maximum current level) and the 3rd branch will be in PWM mode with current level 1530. If brightness is between 75% and 100%, the first three branches will stay ON (e.g., maximum current level) and the 4th branch will be in PWM mode with current level 1540.

Note that with N branches, the peak current of each branch will be 1/N of one branch case. A maximum to threshold current ratio can be as high as 20 or even higher. Therefore, for PWM mode it is realistic to have 8 branches or even 16 branches without compromising front of screen performance.

Control code can be used to allocate branch control, PWM control, and optional dither control in accordance with one embodiment. Bit 0 can provide dither control, Bits 1-8 can provide PWM control, and Bits 9-11 can provide branch control.

For 4 branches, 2 MSB are used for branch control. For 8-branch case, 3 MSB are used for branch control. Generally, N MSB is needed to control 2\hat{ }N branches. Table 1 illustrates Branch control with 3 control bits and 8 branches.

| Control Bits | | | Branch status | | | | | | | |
|---|---|---|---|---|---|---|---|---|---|---|
| Bit[11] | Bit[10] | Bit[9] | 1 | 2 | 3 | 4 | 5 | 6 | 7 | 8 |
| 0 | 0 | 0 | PWM | OFF | OFF | OFF | OFF | OFF | OFF | OFF |
| 0 | 0 | 1 | ON | PWM | OFF | OFF | OFF | OFF | OFF | OFF |
| 0 | 1 | 0 | ON | ON | PWM | OFF | OFF | OFF | OFF | OFF |
| 0 | 1 | 1 | ON | ON | ON | PWM | OFF | OFF | OFF | OFF |
| 1 | 0 | 0 | ON | ON | ON | ON | PWM | OFF | OFF | OFF |
| 1 | 0 | 1 | ON | ON | ON | ON | ON | PWM | OFF | OFF |
| 1 | 1 | 0 | ON | ON | ON | ON | ON | ON | PWM | OFF |
| 1 | 1 | 1 | ON | ON | ON | ON | ON | ON | ON | PWM |

It may be necessary to prevent turning ON PWM branch having very small duty cycles to improve linearity. One option is to set a minimum pulse width for a PWM branch. If the calculated PWM pulse width is smaller than the minimum value, then the PWM will turn ON for the predefined minimum pulse width. However, the ON time of a previous PWM branch can be reduced to compensate for this modification to the calculated PWM pulse width.

Table 2 illustrates a comparison of a single branch vs N branches for different parameters of LED circuitry.

| | | | | | PLL | PLL | | | |
|---|---|---|---|---|---|---|---|---|---|
| Max | | Branch max | PWM | PWM | frequency | frequency | Min | PWM | Dimming |
| current | Branch | current | resolution | current step | @20k PWM | @2k PWM | brightness | duty @ min | Range @ min |
| [mA] | # | [mA] | [bits] | [uA] | [MHz] | [MHz] | [%] | brightness | 0.5% Duty |
| 10 | 1 | 10 | 11 | 4.883 | 40.96 | 4.10 | 0.5 | 0.5 | 200:1 |
| 10 | 1 | 10 | 12 | 2.441 | 81.92 | 8.19 | 0.5 | 0.5 | 200:1 |
| 10 | 1 | 10 | 13 | 1.221 | 163.84 | 16.38 | 0.5 | 0.5 | 200:1 |
| 10 | 1 | 10 | 14 | 0.610 | 327.68 | 32.77 | 0.5 | 0.5 | 200:1 |
| 10 | 1 | 10 | 15 | 0.305 | 655.36 | 65.54 | 0.5 | 0.5 | 200:1 |
| 10 | 1 | 10 | 16 | 0.153 | 1310.72 | 131.07 | 0.5 | 0.5 | 200:1 |
| 10 | 8 | 1.25 | 8 | 4.883 | 5.12 | 0.51 | 0.5 | 4 | 1600:1 |
| 10 | 16 | 0.625 | 7 | 4.883 | 2.56 | 0.26 | 0.5 | 8 | 3200:1 |
| 10 | 8 | 1.25 | 9 | 2.441 | 10.24 | 1.02 | 0.5 | 4 | 1600:1 |
| 10 | 16 | 0.625 | 8 | 2.441 | 5.12 | 0.51 | 0.5 | 8 | 3200:1 |
| 10 | 8 | 1.25 | 10 | 1.221 | 20.48 | 2.05 | 0.5 | 4 | 1600:1 |
| 10 | 16 | 0.625 | 9 | 1.221 | 10.24 | 1.02 | 0.5 | 8 | 3200:1 |
| 10 | 8 | 1.25 | 11 | 0.610 | 40.96 | 4.10 | 0.5 | 4 | 1600:1 |
| 10 | 16 | 0.625 | 10 | 0.610 | 20.48 | 2.05 | 0.5 | 8 | 3200:1 |
| 10 | 8 | 1.25 | 12 | 0.305 | 81.92 | 8.19 | 0.5 | 4 | 1600:1 |
| 10 | 16 | 0.625 | 11 | 0.305 | 40.96 | 4.10 | 0.5 | 8 | 3200:1 |
| 10 | 8 | 1.25 | 13 | 0.153 | 163.84 | 16.38 | 0.5 | 4 | 1600:1 |
| 10 | 16 | 0.625 | 12 | 0.153 | 81.92 | 8.19 | 0.5 | 8 | 3200:1 |

As shown in Table 2, a PWM duty cycle is multiplied by a number of branches. Therefore, accuracy can be improved at low duty cycle for the same dimming range. Meanwhile, a PLL frequency is reduced to ½\hat{ }N. With the same clock frequency, very high resolution can be achieved. Dimming range can also be significantly increased if the same minimum duty cycle as that of single branch is used for all branches.

The new control mechanism for a current mirror based LED driver provides high accuracy at low duty cycles, a high dimming range, and a high resolution with a reduced clock frequency compared to prior approaches.

In accordance with various aspects of the subject disclosure, an electronic device with a display is provided. In accordance with various aspects of the subject disclosure, an electronic device with a display is provided. The display includes a plurality of light-emitting diodes. The display includes a plurality of light-emitting diodes and first and second driver circuits coupled to the plurality of light-emitting diodes. The first driver circuit is configured to receive a first pulse-width modulated (PWM) signal to control a first current mirror branch and the second driver circuit to receive a second PWM signal to control a second current mirror branch to provide extra N bits of resolution for controlling the plurality of the light-emitting diodes.

In accordance with other aspects of the subject disclosure, a computer implemented method for operating a display of an electronic device comprises generating, with a light-emitting diode (LED) circuit of the display, a first pulse-width modulated (PWM) signal to control a first current mirror branch of a first driver stage. The method includes generating a second PWM signal to control a second current mirror branch of a second driver stage to provide an extra N bits of resolution for controlling a plurality of light-emitting diodes of the LED circuit.

In accordance with other aspects of the subject disclosure, backlight circuitry comprises a plurality of light-emitting diodes to generate backlight for a display and first and second driver circuits coupled to the plurality of light-emitting diodes. The first driver circuit is configured to receive a first pulse-width modulated (PWM) signal to control a first current mirror branch and the second driver circuit to receive a second PWM signal to control a second current mirror branch to provide extra N bits of resolution for controlling the plurality of the light-emitting diodes.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device with a display, the display comprising:
a plurality of light-emitting diodes; and
first and second driver circuits coupled to the plurality of light-emitting diodes, wherein the first driver circuit is configured to receive a first pulse-width modulated (PWM) signal to control a first current mirror branch and the second driver circuit to receive a second PWM signal to control a second current mirror branch to provide an extra N bits of resolution for controlling the plurality of the light-emitting diodes.

2. The electronic device of claim 1, wherein the first current mirror branch to second current mirror branch ratio is 1:½^{N}.

3. The electronic device of claim 1, wherein the second current mirror branch to provide extra N bits of resolution during a single PWM period.

4. The electronic device of claim 1, wherein the second current mirror branch to provide extra N bits of resolution without increasing a clock frequency for the first PWM signal.

5. The electronic device of claim 1, wherein the first and second PWM signals control a brightness level of the plurality of light-emitting diodes, which is coupled to a voltage supply circuitry.

6. The electronic device of claim 1, wherein the display comprises a current source to set a current level of the first and second current mirror branches.

7. The electronic device of claim 1, wherein the display comprises a first reference current to set an accurate reference with trim for the first current mirror branch and a second reference current to set an accurate reference with trim for the second current mirror branch.

8. The electronic device of claim 1, wherein the display comprises:
a first PWM controller to receive a counter clock signal and brightness level information and to generate the first PWM signal for controlling the first current mirror branch to provide M bits of resolution; and
a second PWM controller to receive the counter clock signal and brightness level information and to generate the second PWM signal for controlling the second current mirror branch to provide N bits of resolution.

9. The electronic device of claim 1, wherein a counter clock signal is designed for M bits of resolution with the resolution being based on the counter clock signal and a PWM clock signal.

10. A computer implemented method for operating a display of an electronic device, comprising:
generating, with a light-emitting diode (LED) circuit of the display, a first pulse-width modulated (PWM) signal to control a first current mirror branch of a first driver stage; and
generating a second PWM signal to control a second current mirror branch of a second driver stage to provide an extra N bits of resolution for controlling a plurality of light-emitting diodes of the LED circuit.

11. The computer implemented method of claim 10, wherein the first current mirror branch to second current mirror branch ratio is 1:½^{N}.

12. The computer implemented method of claim 10, wherein the second current mirror branch to provide extra N bits of resolution during a single PWM period.

13. The computer implemented method of claim 10, wherein the LED circuit does not have a digital to analog converter (DAC) to minimize area.

14. The computer implemented method of claim 10, wherein the first and second PWM signals control a brightness level of the plurality of light-emitting diodes, which is coupled to a voltage supply circuitry.

15. The computer implemented method of claim 10, further comprising:
generating a third PWM signal to control a third current mirror branch of a third driver stage for controlling the plurality of light-emitting diodes of the LED circuit.

16. The computer implemented method of claim 15, wherein the first PWM signal has pulses with a first step size, the second PWM signal has pulses with a second step size, and the third PWM signal has pulses with a third step size.

17. Backlight circuitry, comprising:
a plurality of light-emitting diodes to generate backlight for a display; and
first and second driver circuits coupled to the plurality of light-emitting diodes, wherein the first driver circuit is configured to receive a first pulse-width modulated (PWM) signal to control a first current mirror branch and the second driver circuit to receive a second PWM signal to control a second current mirror branch to provide an extra N bits of resolution for controlling the plurality of the light-emitting diodes.

18. The backlight circuitry of claim 17, wherein the first current mirror branch to second current mirror branch ratio is 1:½^{N}.

19. The backlight circuitry of claim 17, wherein the second current mirror branch to provide extra N bits of resolution during a single PWM period.

20. An electronic device with a display, the display comprising:
a channel of light-emitting diodes; and
current mirror circuitry coupled to the channel of light-emitting diodes, wherein the current mirror circuitry has N branches and the current mirror circuitry is configured to receive a first pulse-width modulated (PWM) signal to control a first current mirror branch and to receive a second PWM signal to control a second current mirror branch for controlling the channel of the light-emitting diodes.

21. The electronic device of claim 20, further comprising:
a current source to provide a reference current to the current mirror circuitry.

22. The electronic device of claim 21, wherein each of the N branches has a same targeted current ratio relative to the reference current.

23. The electronic device of claim 20, wherein the first current mirror branch has a current level to cause a brightness that is less than a first brightness level while being in a PWM mode.

24. The electronic device of claim 23, wherein the first current mirror branch remains ON at a maximum current level after being in the PWM mode while the second current mirror has a current level to cause a brightness that is greater than a first brightness level and less than a second brightness level while being in a PWM mode.

25. The electronic device of claim 24, wherein the first and second current mirror branches remain ON at a maximum current level after being in the PWM mode while a third current mirror has a current level to cause a brightness that is greater than the second brightness level and less than a third brightness level while being in a PWM mode.

26. The electronic device of claim 20, wherein N equals 8 branches with a bit for dither control, 8 bits for PWM control of the 8 branches and 3 bits for control code to allocate branch control.
